(19) United States
(12) Patent Application Publication
(10) Pub. No.: US 2026/0307016 A1
(43) Pub. Date: Oct. 8, 2026

(54) SUBSTRATE FOR LIQUID FILTER AND LIQUID FILTER

(71) Applicant: TEIJIN LIMITED, Osaka-shi, Osaka (JP)

(72) Inventor: Yu NAGAO, Osaka-shi, Osaka (JP)

(73) Assignee: TEIJIN LIMITED, Osaka-shi, Osaka (JP)

(21) Appl. No.: 19/167,466

(22) PCT Filed: Mar. 11, 2024
(86) PCT No.: PCT/JP2024/009380

§ 371 Date: Sep. 22, 2025

(30) Foreign Application Priority Data
Mar. 28, 2023 (JP) 2023-052236

(51) Int. Cl. B01D 69/02; B01D 71/26

(52) U.S. Cl. CPC B01D 69/02; B01D 71/261; B01D 2325/02833; B01D 2325/04; B01D 2325/20; B01D 2325/34

(57) ABSTRACT

Provided is a substrate for a liquid filter including a polyolefin microporous membrane having a pore diameter of 1 nm to 35 nm and a crystallinity of polyolefin of 45% or more.

### TECHNICAL FIELD

The present disclosure relates to a substrate for a liquid filter and a liquid filter.

### BACKGROUND ART

The liquid composition used in the semiconductor lithography step is filtered through a liquid filter for the purpose of removing minute foreign substances from the liquid composition before use. A filter medium obtained by pleating a dense porous membrane, a filter medium obtained by bundling hollow fibers, and the like are housed inside the liquid filter.

Conventionally, a polyolefin microporous membrane has been known as a porous membrane used for a filter medium of a liquid filter. Patent Literatures 1 to 7 disclose a substrate for a liquid filter formed of a polyolefin microporous membrane having a small pore diameter.

The polyolefin does not contain a halogen element, and therefore, the liquid filter in which the filter medium is a polyolefin microporous membrane is advantageous in that the disposal treatment after use is less limited and the environmental load is small.

### CITATION LIST

### Patent Literature

Patent Literature 1: WO2014/181760
Patent Literature 2: WO2014/181761
Patent Literature 3: WO2014/181762
Patent Literature 4: JP2014-217800A
Patent Literature 5: JP2014-218563A
Patent Literature 6: JP2018-167198A
Patent Literature 7: WO2020/022321

### SUMMARY OF INVENTION

### Technical Problem

In a liquid filter, a filter medium is generally washed after production and before use. By washing the filter medium, fine powder generated during the production of the liquid filter, dust in the air, and the like are removed from the filter medium to prevent the foreign substances from being mixed into the liquid to be treated by the liquid filter.

In washing the filter medium, a trace amount of metal contained in the filter medium itself is eluted and removed. The polyolefin microporous membrane sometimes contains a metal (calcium, zinc, or the like, which is introduced by the polyolefin itself as a raw material, and is derived from a polymerization catalyst of polyolefin or an additive after polymerization (for example, metal soap)). These metals are eluted from the polyolefin microporous membrane and removed during washing.

It is preferable to remove the metal from the filter medium before use, because it may elute into the liquid composition used in the lithography step during filtration and reduce the production yield of the semiconductor.

Incidentally, as a wiring pattern of a semiconductor is miniaturized and densified, there is an increasing need to remove even extremely fine foreign matters (for example, fine particles having a particle diameter of several nm) from a liquid composition used in a lithography step. Therefore, a liquid filter including a denser filter medium is required.

However, the denser the filter medium is, the lower the washing efficiency tends to decrease. For the polyolefin microporous membrane, the smaller the pore diameter is, the lower the efficiency of eluting and removing the metal contained in the polyolefin microporous membrane during washing of the filter medium is.

Furthermore, densification of the polyolefin microporous membrane makes it difficult to elute and remove the metal due to the following mechanism.

Generally, densification of a polyolefin microporous membrane is achieved by using an ultra-high molecular weight polyolefin as a raw material. Therefore, as a measure to further densify the polyolefin microporous membrane, it is conceivable to increase the blending ratio of the ultra-high molecular weight polyolefin, in other words, to reduce the blending ratio of the high density polyolefin. However, in this case, in the polyolefin microporous membrane, the proportion of crystalline component of the polyolefin decreases, and the proportion of amorphous component increases. The metal contained in the raw material polyolefin is likely to remain in the amorphous component of the polyolefin, and moreover, the metal inside the amorphous component is less likely to be eluted during washing of the filter medium.

For the above reasons, it has been difficult to achieve both densification of the polyolefin microporous membrane and removal of residual metals.

The present disclosure has been made under the above circumstances.

An object of the present disclosure is to provide a substrate for a liquid filter which, although having a relatively small pore diameter, allows residual metals to be easily removed by washing.

### Solution to Problem

A specific means for solving the above problem includes the following aspects.

<1>

A substrate for a liquid filter including a polyolefin microporous membrane having a pore diameter of 1 nm to 35 nm and a crystallinity of polyolefin of 45% or more.

<2>

The substrate for a liquid filter according to <1>, in which the polyolefin microporous membrane has a thickness of 3 μm to 20 μm.

<3>

The substrate for a liquid filter according to <1> or

<2>, in which the polyolefin microporous membrane has a porosity of 35% to 70%.
<4>

The substrate for a liquid filter according to any one of <1> to <3>, in which the polyolefin microporous membrane has a water flow rate of 0.003 L/min/ft²/psi to 0.180 L/min/ft²/psi.

<5>

The substrate for a liquid filter according to any one of <1> to <4>, in which a weight average molecular weight of all polyolefins constituting the polyolefin microporous membrane is 800,000 or more.

<6>

The substrate for a liquid filter according to any one of <1> to <5>, in which the polyolefin microporous membrane is a polyethylene microporous membrane.

<7>

A liquid filter including the substrate for a liquid filter according to any one of <1> to <6>.

### Advantageous Effects of Invention

According to the present disclosure, there is provided a substrate for a liquid filter which, although having a relatively small pore diameter, allows residual metals to be easily removed by washing.

### DESCRIPTION OF EMBODIMENTS

Hereinafter, embodiments of the present disclosure will be described. These descriptions and examples are illustrative of embodiments and do not limit the scope of the embodiments.

In the present disclosure, a numerical range indicated using “to” indicates a range including numerical values described before and after “to” as a minimum value and a maximum value, respectively.

In a numerical range described stepwise in the present disclosure, an upper limit value or a lower limit value described in one numerical range may be replaced with an upper limit value or a lower limit value of another numerical range described in a stepwise manner. In addition, in the numerical range described in the present disclosure, the upper limit value of the lower limit value of the numerical range may be replaced with a value shown in Examples.

In the present disclosure, the term “step” includes not only an independent step but also a step that cannot be clearly distinguished from other steps as long as the purpose of the step is achieved.

In the present disclosure, when referring to the amount of each component in the composition and there are a plurality of substances corresponding to each component in the composition, the amount means the total amount of the plurality of substances present in the composition unless otherwise specified.

In the present disclosure, a plurality of types of particles corresponding to each component may be included. When there are a plurality of types of particles corresponding to each component in the composition, the particle diameter of each component means a value of a mixture of the plurality of types of particles present in the composition, unless otherwise specified.

In the present disclosure, MD (Machine Direction) means a longitudinal direction in a polyolefin microporous membrane produced in an elongated shape, and TD (Transverse Direction) means a direction orthogonal to MD in a surface direction of the polyolefin microporous membrane. In the present disclosure, TD is also referred to as a “width direction”.

In the present disclosure, when the lamination relationship of the layers constituting the liquid filter or the substrate for a liquid filter is expressed by “upper” and “lower”, a layer closer to the polyolefin microporous membrane is referred to as “lower”, and a layer farther from the polyolefin microporous membrane is referred to as “upper”.

In the present disclosure, the volume of the microporous membrane or the porous layer excluding pores is referred to as a “solid content volume”.

### <Substrate for Liquid Filter>

The substrate for a liquid filter of the present disclosure includes a polyolefin microporous membrane.

The substrate for a liquid filter of the present disclosure may be a substrate formed only of a polyolefin microporous membrane, or may be a substrate formed by laminating a polyolefin microporous membrane and another porous film or a porous layer. The substrate for a liquid filter of the present disclosure may have one polyolefin microporous membrane, or may have two or more polyolefin microporous membranes (that is, two or more polyolefin microporous membranes may overlap each other).

An example of the embodiment of the substrate for a liquid filter of the present disclosure is a substrate formed only of a polyolefin microporous membrane.

An example of the embodiment of the substrate for a liquid filter of the present disclosure is a substrate having a single-layer structure composed of only one polyolefin microporous membrane.

The polyolefin microporous membrane included in the substrate for a liquid filter of the present disclosure has a pore diameter of 1 nm to 35 nm and a crystallinity of polyolefin of 45% or more.

In the substrate for a liquid filter of the present disclosure, fine particles (for example, particles having a particle diameter of 5 nm) contained in the liquid to be treated can be separated by filtration due to that the pore diameter of the polyolefin microporous membrane is 1 nm to 35 nm.

The substrate for a liquid filter of the present disclosure, by having a crystallinity of the polyolefin constituting the polyolefin microporous membrane of 45% or more, allows residual metals to be easily removed by washing even when residual metals are contained.

The metal contained in the raw material polyolefin is likely to remain in the amorphous component of the polyolefin in the polyolefin microporous membrane, and the metal inside the amorphous component is less likely to be eluted during washing of the filter medium. When the crystallinity of the polyolefin constituting the polyolefin microporous membrane is 45% or more, even when the polyolefin microporous membrane contains a metal, the metal can be easily removed by washing.

Hereinafter, the polyolefin microporous membrane of the substrate for a liquid filter of the present disclosure will be described in detail.

### [Polyolefin Microporous Membrane]

The polyolefin microporous membrane refers to a membrane having a structure in which fibril-like polyolefin forms a three-dimensional network, containing a large number of micropores inside, and has a structure in which the micropores are connected, allowing gas or liquid to pass from one surface to the other surface.

In the polyolefin microporous membrane, the polyolefin accounts for preferably 90% by mass or more, more preferably 95% by mass or more, and still more preferably 99% by mass or more of the polyolefin microporous membrane.

The polyolefin microporous membrane may contain an organic filler, an inorganic filler, a surfactant, or the like as long as the effects of the present disclosure are not impaired.

The polyolefin microporous membrane may be hydrophobic or hydrophilic. Since polyolefin is a hydrophobic resin, the polyolefin microporous membrane itself is hydrophobic. The polyolefin microporous membrane may be a hydrophobic polyolefin microporous membrane not subjected to a hydrophilization treatment or a polyolefin microporous membrane imparted hydrophilicity by a hydrophilization treatment.

Examples of the treatment method for hydrophilizing the polyolefin microporous membrane include physical hydrophilization treatment (plasma treatment, corona discharge treatment, ultraviolet irradiation, electron beam irradiation, and the like), coating treatment with a surfactant or a hydrophilic material (cellulose, polyvinyl alcohol, or the like), and graft polymerization of a hydrophilic monomer.

### [Pore Diameter]

The pore diameter of the polyolefin microporous membrane is 1 nm to 35 nm.

When the pore diameter of the polyolefin microporous membrane is 1 nm or more, sufficient liquid permeability can be obtained. From this viewpoint, the pore diameter of the polyolefin microporous membrane is preferably 5 nm or more, more preferably 10 nm or more, still more preferably 11 nm or more, and particularly preferably 13 nm or more.

When the pore diameter of the polyolefin microporous membrane is 35 nm or less, fine particles (for example, particles having a particle diameter of 5 nm) contained in the liquid to be treated can be separated by filtration. From this viewpoint, the pore diameter of the polyolefin microporous membrane is preferably 33 nm or less, more preferably 32 nm or less, still more preferably 25 nm or less, and particularly preferably 22 nm or less.

The pore diameter of the polyolefin microporous membrane is a flow pore diameter measured by the half dry method defined in ASTM E1294-89. The flow pore diameter is measured using perm porometer (PMI, Capillary Flow Porometer, model: CFP-1500A) with a fluorine-based inert liquid (trade name: Fluorinert, surface tension: 16.0 dyn/cm) as an immersion liquid. The measurement temperature is 25° C., and the measurement pressure is changed in a range of 0 psi to 500 psi.

Along the TD of the polyolefin microporous membrane, the flow pore diameter is measured at a total of five points including a center, two points located 50 mm from the center toward each end, and two points located 100 mm from the center toward each end, and the average value thereof is defined as the pore diameter of the polyolefin microporous membrane.

### [Crystallinity of Polyolefin]

The crystallinity of the polyolefin constituting the polyolefin microporous membrane is 45% or more, preferably 46% or more, more preferably 47% or more, even more preferably 48% or more, and particularly preferably 49% or more, from the viewpoint of easy removal of residual metals by washing.

The crystallinity of the polyolefin constituting the polyolefin microporous membrane is preferably 65% or less, more preferably 60% or less, even more preferably 58% or less, and particularly preferably 578 or less, from the viewpoint of densifying the polyolefin microporous membrane. When the polyolefin microporous membrane is a polyethylene microporous membrane, the crystallinity of polyethylene is also preferably in the above range.

The crystallinity of the polyolefin is determined by wide-angle X-ray diffraction (WAXD).

The polyolefin microporous membrane is cut out from the center of the TD direction into a size of 10 mm in MD×3 mm in TD, and laminated to a thickness of 1 mm with directions of MD and TD aligned, and this is used as a sample.

The sample is fixed to the sample holder of the 2D-WAXD device (model number: NANO-Viewer, Rigaku Corporation). At this time, the MD of the sample is fixed in the meridian direction such that the X-rays are perpendicularly incident on the surface of the polyolefin microporous membrane. The transmission measurement is performed under the following conditions.
X-ray generator: ultrax18
Tube voltage/tube current: 45 kV/60 mA
Target: CuKα (λ=0.1542 nm)
Camera length: 95 mm
Measurement time: 10 minutes
Measurement temperature: room temperature
Detector: imaging plate

The two-dimensional data obtained by the imaging plate is converted into a 2θ profile, and peak fitting is performed in the range of 2θ=8° to 33° using Gaussian function/Lorentz function=50/50. The integrated intensity of each peak is obtained, and the crystalline integrated intensity Ic which is the sum of the peak intensities of the crystalline components, and the amorphous integrated intensity Ia which is the sum of the peak intensity of the amorphous components, are determined. The crystallinity Xc is calculated using the following formula.

$$Xc ( \% ) = Ic / ( Ic + Ia ) \times 100$$

### [Membrane Thickness]

The thickness of the polyolefin microporous membrane is preferably 3 μm or more, more preferably 4 μm or more, still more preferably 5 μm or more, and particularly preferably 6 μm or more, from the viewpoint of obtaining mechanical strength and durability.

The thickness of the polyolefin microporous membrane is preferably 20 μm or less, more preferably 18 μm or less, even more preferably 16 μm or less, still more preferably 15 μm or less, and particularly preferably 14 μm or less, from the viewpoint of obtaining sufficient liquid permeability, the viewpoint of relatively small filtration pressure, the viewpoint of increasing the filtration area by pleating or the like, the viewpoint of easy processing of increasing the filtration area, and the like.

The thickness of the polyolefin microporous membrane is determined by measuring 10 points with a contact-type film thickness meter and averaging the measured values. 10 measurement points are set at regular intervals along the TD from the vicinity of one end to the vicinity of the other end.

### [Porosity]

The porosity of the polyolefin microporous membrane is preferably 35% or more, more preferably 38% or more, even more preferably 40% or more, and particularly preferably 42% or more, from the viewpoint of obtaining sufficient liquid permeability, and from the viewpoint of relatively small filtration pressure.

The porosity of the polyolefin microporous membrane is preferably 70% or less, more preferably 66% or less, even more preferably 60% or less, still more preferably 57% or less, and particularly preferably 55% or less, from the viewpoint of obtaining mechanical strength and durability.

The porosity ε (%) of the polyolefin microporous membrane is determined by the following formula.

$$ε ( \% ) = \{ 1 - Ws / ( ds \cdot t ) \} \times 100$$

Ws: Basis weight (g/m²) of the polyolefin microporous membrane: The polyolefin microporous membrane is cut into squares of 10 cm in MD×10 cm in TD from a total of three locations along the TD, one at the center and one near each end. The mass of each sample is measured, and the mass is divided by the area. Further, an average of the values at the center and near each end of the TD is calculated and defined as Ws.
ds: True density (g/cm³) of the polyolefin microporous membrane: 0.96.
t: Membrane thickness (μm) of the polyolefin microporous membrane: obtained as described above.

### [Water Flow Rate]

The water flow rate of the polyolefin microporous membrane is preferably 0.003 L/min/ft²/psi or more, more preferably 0.004 L/min/ft²/psi more, still more preferably 0.005 L/min/ft²/psi or more, and particularly preferably 0.007 L/min/ft²/psi or more, from the viewpoint of obtaining sufficient liquid permeability for a long period of time.

The water flow rate of the polyolefin microporous membrane is preferably 0.180 L/min/ft²/psi or less, more preferably 0.170 L/min/ft²/psi or less, still more preferably 0.150 L/min/ft²/psi or less, and particularly preferably 0.140 L/min/ft²/psi or less, from the viewpoint of obtaining the collecting performance of fine particles (for example, particles having a particle diameter of 5 nm).

The water flow rate of the polyolefin microporous membrane is determined by the following measurement method.

The polyolefin microporous membrane is cut into squares of 40 mm×40 mm from a total of three locations, one at the center and one near each end of TD, immersed in ethanol, and dried at room temperature. The polyolefin microporous membrane is placed in a liquid permeable cell having a diameter of 37 mm (liquid permeable area: 10.75 cm²). 100 ml of pure water is filtered through the membrane, and the time T1 (min) required for the entire volume to pass through is measured, under environmental conditions at 24° C. room temperature and a differential pressure of 90 kPa. From the liquid volume V (100 ml) of the pure water, the time Tl (min), and the liquid permeation area S (10.75 cm²), the water flow rate Vs (the water flow rate per unit time (min)·unit area (ft²) under 1 psi differential pressure, and the unit: L/min/ft²/psi) is calculated by the following formula. Further, an average of the values at the center and near each end of TD is calculated.

$$Vs = ( V / 1000 ) / T 1 / ( S / 929.03 ) / ( 90 / 6.895 )$$

### [Thermal Shrinkage Rate]

The thermal shrinkage of the polyolefin microporous membrane at a temperature of 105° C. is preferably 45% or less, more preferably 40% or less, and still more preferably 30% or less in MD from the viewpoint of heat resistance.

The thermal shrinkage of the polyolefin microporous membrane at a temperature of 105° C. is preferably 20% or less, more preferably 15% or less, and still more preferably 10% or less in TD from the viewpoint of heat resistance.

The thermal shrinkage of the polyolefin microporous membrane is determined by the following measurement method.

The polyolefin microporous membrane is cut into squares of 10 cm in MD×10 cm in TD from a total of three locations, one at the center and one near each end of TD to obtain samples. The samples are placed in an oven whose inside temperature is kept at 105° C. for 30 minutes. The samples are taken out from the oven, and the MD length and TD length of the samples are measured. The thermal shrinkage rates (%) of each of MD and TD={(length before heat treatment−length after heat treatment)/length before heat treatment×100} are calculated. Further, an average of the values at the center and near each end of TD is calculated.

### [Polyolefin]

Examples of the polyolefin constituting the polyolefin microporous membrane include homopolymers such as ethylene, propylene, butylene, and methylpentene (that is, polyethylene, polypropylene, polybutylene, and polymethylpentene), copolymers, and mixtures thereof.

The polyolefin microporous membrane is preferably a microporous membrane formed using two or more types of polyolefins that differ from each other in at least one property selected from the type of monomer, degree of polymerization, degree of branching, crystallinity, stretchability, and molecular orientation. By using two or more polyolefins, it is easy to form a network structure in the polyolefin microporous membrane by fibrillation at the time of stretching.

The weight average molecular weight of all polyolefins constituting the polyolefin microporous membrane is preferably 800,000 or more, more preferably 850,000 or more, still more preferably 900,000 or more, even more preferably 950,000 or more, and particularly preferably 970,000 or more, from the viewpoint of densifying the polyolefin microporous membrane.

The weight average molecular weight of all polyolefins constituting the polyolefin microporous membrane is preferably 3,500,000 or less, more preferably 3,200,000 or less, even more preferably 3,100,000 or less, and particularly preferably 3,000, 000 or less from the viewpoint of facilitating uniform melting during melt-kneading.

The weight average molecular weight of all polyolefins constituting the polyolefin microporous membrane is determined by heating and dissolving the polyolefin microporous membrane in o-dichlorobenzene and performing measurement under conditions of a column temperature of 135° C. and a flow rate of 1.0 mL/min by gel permeation chromatography (system: Alliance GPC 2000 type manufactured by Waters Corporation, column: GMH6-HT and GMH6-HTL). Molecular weight monodisperse polystyrene (Tosoh Corporation) is used for molecular weight calibration.

The polyolefin constituting the polyolefin microporous membrane is preferably polyethylene. That is, the polyolefin microporous membrane is preferably a polyethylene microporous membrane. In the present disclosure, the polyethylene microporous membrane means a microporous membrane in which the resin having the largest mass ratio in the entire resin is polyethylene.

In the polyethylene microporous membrane, the polyethylene accounts for preferably 90% by mass or more, more preferably 95% by mass or more, and still more preferably 99% by mass or more of the polyethylene microporous membrane.

The polyethylene microporous membrane may contain an organic filler, an inorganic filler, a surfactant, or the like as long as the effects of the present disclosure are not impaired.

The polyethylene microporous membrane is preferably a microporous membrane formed using two or more types of polyethylene that differ from each other in at least one property selected from degree of polymerization, degree of branching, crystallinity, stretchability, and molecular orientation. By using two or more types of polyethylene, it is easy to form a network structure in the polyethylene microporous membrane by fibrillation at the time of stretching.

Examples of the polyethylene constituting the polyethylene microporous membrane include ultra-high molecular weight polyethylene, high-density polyethylene, and a mixture of ultra-high molecular weight polyethylene and high-density polyethylene.

From the viewpoint of densifying the polyethylene microporous membrane, the polyethylene microporous membrane preferably contains ultra-high molecular weight polyethylene having a weight average molecular weight of 3,000,000 to 6,000,000. The polyethylene microporous membrane preferably contains 50% by mass to 95% by mass, more preferably 60% by mass to 90% by mass, and still more preferably 70% by mass to 85% by mass of the ultra-high molecular weight polyethylene having weight average molecular weight of 3,000,000 to 6,000,000.

The polyethylene microporous membrane preferably contains an ultra-high molecular weight polyethylene having a weight average molecular weight of 3,000,000 to 6,000,000 and a high-density polyethylene having a weight average molecular weight of 200,000 to 800,000 and a density of 0.92 g/cm³ to 0.98 g/cm³. The mass ratio of both polyethylene (ultra-high molecular weight polyethylene: high-density polyethylene) contained in the polyethylene microporous membrane is preferably 50:50 to 95:5, more preferably 60:40 to 90:10, and still more preferably 70:30 to 85:15, from the viewpoint of increasing the crystallinity of polyethylene and from the viewpoint of producing a microporous membrane having a small pore diameter.

The weight average molecular weight of all polyethylenes constituting the polyethylene microporous membrane is preferably 800,000 or more, more preferably 850,000 or more, still more preferably 900,000 or more, even more preferably 950,000 or more, and particularly preferably 970,000 or more, from the viewpoint of densifying the polyethylene microporous membrane.

The weight average molecular weight of all polyethylenes constituting the polyethylene microporous membrane is preferably 3,500,000 or less, more preferably 3,200,000 or less, even more preferably 3,100,000 or less, and particularly preferably 3,000,000 or less from the viewpoint of facilitating uniform melting during melt-kneading.

The content of calcium contained in the polyolefin constituting the polyolefin microporous membrane depends on the raw material polyolefin, and is preferably, for example, in the following range.

In one embodiment, the content of calcium contained in the polyolefin is preferably 50 ppm or less, more preferably 38 ppm or less, still more preferably 35 ppm or less, and particularly preferably 34 ppm or less.

In another embodiment, the content of calcium contained in the polyolefin is preferably 1000 ppb or less, more preferably 500 ppb or less, still more preferably 400 ppb or less, and particularly preferably 300 ppb or less.

The content of calcium contained in the polyolefin is, for example, 0 ppb or more, 10 ppb or more, 20 ppb or more, 50 ppb or more, or 100 ppb or more.

Examples of the method for adjusting the calcium content contained in the polyolefin include: adjusting the amount of metal soap (calcium stearate or the like) added to the polyolefin after polymerization; acid-washing the polyolefin; and removing the polymerization catalyst remaining in the polyolefin by a demineralization step.

The calcium content of the polyolefin is quantified by adding ultra-high purity nitric acid to the polyolefin, performing microwave decomposition on the polyolefin to obtain a sample, and analyzing it using ICP-MS (inductively coupled plasma mass spectrometry, apparatus name: Aglient 7500 cs, Agilent Technologies Co., Ltd.).

### [Method for Producing Polyolefin Microporous Membrane]

The polyolefin microporous membrane can be produced, for example, by a production method including the following steps (1) to (6).
Step (1): a step of preparing a polyolefin solution containing a polyolefin and a solvent.
Step (2): a step of melt-kneading the polyolefin solution, extruding the melt-kneaded product from the die, and cooling and solidifying the extrudate to obtain a gel-like molded product.
Step (3): a step of squeezing out the solvent from the gel-like molded product.
Step (4): a step of stretching the gel-like molded product in at least one direction to obtain a polyolefin microporous membrane.
Step (5): a step of washing the polyolefin microporous membrane to remove the solvent.
Step (6): a step of annealing the polyolefin microporous membrane.

By controlling each condition of step (1), step (2), and step (4), the crystallinity of the polyolefin constituting the polyolefin microporous membrane can be adjusted. In addition, the film thickness, pore diameter, porosity, water flow rate, and the like of the polyolefin microporous membrane can be adjusted by controlling each condition of step (1) to step (6).

### -Step (1)-

Step (1) is a step of preparing a polyolefin solution containing a polyolefin and a solvent.

The polyolefin in step (1) may be used alone or two or more types thereof may be used. The polyolefin preferably preferably contains polyethylene, and more contains an ultra-high molecular weight polyethylene having a weight average molecular weight of 3,000,000 to 6,000,000 and a high-density polyethylene having a weight average molecular weight of 200,000 to 800,000 and a density of 0.92 g/cm³ to 0.98 g/cm³.

The polyolefin is generally traded in the form of granular pellets or powder. When the polyolefin powder is used in step (1), the particle diameter of the powder is preferably 1 μm to 1000 μm, more preferably 5 μm to 500 μm, and still more preferably 10 μm to 300 μm from the viewpoint of uniformly melt-kneading the polyolefin in step (2) and increasing the crystallinity of the polyolefin.

The particle diameter is a median diameter (d50) of a volume-based particle size distribution. The volume-based particle size distribution is determined by dry measurement using a laser diffraction particle size distribution analyzer (apparatus name: Mastersizer 2000, Malvern Instruments Ltd.).

The solvent used in step (1) is not limited as long as it is a solvent capable of swelling or dissolving polyolefin. The solvent is roughly classified into a non-volatile solvent having a boiling point of 210° C. or higher at atmospheric pressure and a volatile solvent having a boiling point lower than 210° C. at atmospheric pressure.

Examples of the nonvolatile solvent include liquid paraffin, paraffin oil, mineral oil, and castor oil. As the non-volatile solvent, one type may be used alone, or two or more types may be used in combination. As the nonvolatile solvent, liquid paraffin is preferable.

Examples of the volatile solvent include tetralin, ethylene glycol, decalin (also known as decahydronaphthalene), toluene, xylene, diethyltriamine, ethylenediamine, dimethyl sulfoxide, and hexane. As the volatile solvent, one type may be used alone, or two or more types may be used in combination. The volatile solvent is preferably decalin or xylene.

The solvent used in step (1) is preferably a mixed solvent of a nonvolatile solvent and a volatile solvent, more preferably a mixed solvent of liquid paraffin and decalin or xylene, and still more preferably a mixed solvent of liquid paraffin and decalin.

The mixing ratio (mass ratio, nonvolatile solvent: volatile solvent) of the nonvolatile solvent to the volatile solvent is preferably 99:1 to 60:40.

When two or more types of polyolefins are used, the order of mixing the materials when mixing the polyolefin and the solvent is not limited. For example, any of the following modes (a) and (b) may be used.
Mode (a): Two or more types of polyolefins are mixed one by one with a solvent. Two or more types of solvents may be mixed in advance to prepare a mixed solvent, and polyolefins may be mixed one by one with the mixed solvent.
Mode (b): Two or more types of polyolefins are mixed to prepare a polyolefin composition, and the polyolefin composition and the solvent are mixed. Two or more types of solvents may be mixed in advance to prepare a mixed solvent, and the mixed solvent and the polyolefin composition may be mixed.

The polyolefin concentration of the polyolefin solution is preferably 10% by mass to 40% by mass, more preferably 15% by mass to 35% by mass, and still more preferably 20% by mass to 30% by mass, from the viewpoint of imparting mechanical strength, liquid permeability, and collecting performance of fine particles in a well-balanced manner to the polyolefin microporous membrane.

When the polyolefin concentration of the polyolefin solution is 10% by mass or more, the mechanical strength of the polyolefin microporous membrane is ensured.

When the polyolefin concentration of the polyolefin solution is 40% by mass or less, pores are easily formed in the polyolefin microporous membrane.

### -Step (2)-

Step (2) is a step of melt-kneading the polyolefin solution, extruding the melt-kneaded product from the die, and cooling and solidifying the extrudate to obtain a gel-like molded product. The gel-like molded product is preferably formed in a sheet form.

The melt-kneading of the polyolefin solution is preferably performed using a kneading extruder. The kneading extruder is an apparatus that applies pressure and heat to a material to be treated while continuously conveying the material to be treated. The structure of the kneading extruder is generally divided into a material inlet, a barrel, and a die in order from upstream to downstream. A screw is provided inside the barrel. A heater for heating the inside of the barrel is provided around the barrel. The screw may be of a uniaxial type or a biaxial type, and is preferably a biaxial type.

From the viewpoint of sufficiently melting the polyolefin, the temperature of the polyolefin solution in the most downstream region inside the barrel is preferably MP+30° C. to MP+150° C., more preferably MP+40° C. to MP+140° C., and still more preferably MP+50° C. to MP+130° C., where MP° C. is the melting point of the polyolefin (when two or more polyolefins are used, the highest melting point among the melting points of these polyolefins is referred to as MP° C.).

The time required for the material to be treated to pass through the inside of the barrel is preferably 1 minute to 10 minutes, more preferably 1 minute 30 seconds to 8 minutes, and still more preferably 2 minutes to 7 minutes. The passage time of the material to be treated can be controlled by the rotation speed of the screw.

From the viewpoint of increasing the film formability of the polyolefin microporous membrane, the temperature of the melt-kneaded product in the die is preferably MP+30° C. to MP+120° C., more preferably MP+40° C. to MP+110° C., and still more preferably MP+50° C. to MP+100° C., where MP° C. is the melting point of the polyolefin (when two or more polyolefins are used, the highest melting point among the melting points of these polyolefins is referred to as MP° C.).

Examples of the method for cooling the extrudate include immersing the extrudate in water or an organic solvent and bringing the extrudate into contact with the cooled metal roll. The cooling temperature is preferably 10° C. to 40° C. When the extrudate is immersed in water, it is preferable to form a water flow in the surface layer of the water bath and suppress the solvent released from the extrudate from adhering to the extrudate.

### -Step (3)-

Step (3) is a step of squeezing out the solvent from the gel-like molded product.

Step (3) is preferably realized by applying pressure to the gel-like molded product. Examples of the method of applying the pressure to the gel-like molded product include conveying the gel-like molded product while pressing the gel-like molded product against a roller or a belt, and passing the gel-like molded product between the pair of rollers. The pressure applied to the gel-like molded product is preferably 0.01 MPa to 0.5 MPa, and more preferably 0.05 MPa to 0.2 MPa. The surface temperature of the roller or the belt is preferably 40° C. to 100° C.

Between step (2) and step (3), it is preferable to heat the gel-like molded product for the purpose of volatilizing a part of the solvent from the gel-like molded product. The temperature of the heat treatment is preferably 50° C. to 100° C. The heat treatment may be performed once, or two or more times with different temperatures. The time of the heat treatment is preferably 5 minutes to 10 minutes per cycle.

By performing the above-described heat treatment in advance, it is possible to shorten the conveyance path in step (3) or moderate the condition (pressure and/or temperature) in step (3).

### -Step (4)-

Step (4) is a step of stretching the gel-like molded product in at least one direction to obtain a polyolefin microporous membrane.

The stretching in step (4) is preferably biaxial stretching. The biaxial stretching may be sequential biaxial stretching in which longitudinal stretching and transverse stretching are performed separately, or simultaneous biaxial stretching in which longitudinal stretching and transverse stretching are simultaneously performed. The biaxial stretching may be performed by stretching a plurality of times in the longitudinal direction and then stretching in the transverse direction, stretching in the longitudinal direction and stretching a plurality of times in the transverse direction, or performing the sequential biaxial stretching and then stretching in the longitudinal direction and/or the transverse direction once or a plurality of times.

The total stretching ratio (product of the longitudinal stretching ratio and the transverse stretching ratio) is preferably 40 times to 200 times, more preferably 45 times to 180 times, and still more preferably 50 times to 150 times from the viewpoint of providing the polyolefin microporous membrane with the liquid permeability and the collecting performance of the fine particles in a well-balanced manner and from the viewpoint of increasing the crystallinity of the polyolefin constituting the polyolefin microporous membrane.

The stretching temperature is preferably 90° C. to 130° C., more preferably 95° C. to 125° C., and still more preferably 100° C. to 120° C., from the viewpoint of increasing the crystallinity of the polyolefin constituting the polyolefin microporous membrane.

After the stretching, a heat-setting treatment is preferably performed. The heat-setting temperature is preferably 100° C. to 140° C., more preferably 105° C. to 135° C., and still more preferably 110° C. to 133° C., from the viewpoint of increasing the crystallinity of the polyolefin constituting the polyolefin microporous membrane.

### -Step (5)-

Step (5) is a step of washing the polyolefin microporous membrane to remove the solvent. In step (5), the polyolefin microporous membrane is preferably washed with a solvent such as a halogenated hydrocarbon (for example, methylene chloride) or a hydrocarbon (for example, hexane).

The polyolefin microporous membrane is preferably washed by immersing the polyolefin microporous membrane in a bath containing a washing solvent. In this case, for the purpose of enhancing the washing effect, it is preferable that the bath is divided into two or more tanks, and the purity of the washing solvent is increased toward the downstream side. This can be realized by pouring the washing solvent into the most downstream bath and flowing the washing solvent toward the upstream side. When the bath is divided into two or more tanks, two, or three or more tanks may be used. From the viewpoint of milder purity gradient of the washing solvent in each tank, three or more tanks are preferable.

The time required for the polyolefin microporous membrane to pass through the entire bath is preferably 60 seconds to 150 seconds, more preferably 70 seconds to 120 seconds, and still more preferably 80 seconds to 100 seconds.

After the polyolefin microporous membrane is withdrawn from the bath containing the washing solvent, the washing solvent is preferably removed by drying. The drying temperature may be a temperature slightly higher than the boiling point of the washing solvent.

### -Step (6)-

Step (6) is a step of performing an annealing treatment on the polyolefin microporous membrane. The annealing treatment is performed, for example, by conveying the polyolefin microporous membrane over a roller having a surface temperature of 100° C. to 130° C., or through a thermostatic chamber having a temperature of 100° C. to 130° C. During the annealing treatment, it is preferable to perform an operation of fixing the width direction of the polyolefin microporous membrane for the purpose of suppressing shrinkage in the width direction of the polyolefin microporous membrane.

Further, the polyolefin microporous membrane may be subjected to an affinity-imparting treatment with respect to the liquid to be treated by the liquid filter.

### <Liquid Filter>

The liquid filter of the present disclosure is a device for removing particles from a liquid to be treated, that may contain or contains fine particles. The particles are contained in the liquid to be treated in a solid state or a gel state.

The liquid filter of the present disclosure includes the substrate for a liquid filter of the present disclosure as a filter medium.

In the liquid filter, in general, after the manufacturing and before use, the filter medium is washed, and the substrate for a liquid filter of the present disclosure allows for easy removal of residual metals by washing, even when such residual metals are present. Therefore, in the liquid filter of the present disclosure, when the filter medium is washed before use, there is little concern that the metal is eluted into the liquid to be treated when the liquid to be treated is filtered.

The liquid filter of the present disclosure includes, for example, a pleated substrate for a liquid filter and a cylindrical housing, and the pleated substrate for a liquid filter is stored inside the housing. The liquid filter of the present disclosure is, for example, a cartridge attachable to and detachable from a filtration device.

The liquid filter of the present disclosure is suitable for the purpose of removing fine particles having a particle diameter of approximately several nanometers from a liquid to be treated. The liquid filter of the present disclosure can be used, for example, in semiconductor manufacturing processes, and display manufacturing processes.

### EXAMPLES

Hereinafter, the substrate for a liquid filter of the present disclosure will be described more specifically with reference to Examples. Materials, amounts used, ratios, treatment procedures, and the like shown in the following examples can be appropriately changed without departing from the gist of the present disclosure. Therefore, the scope of the substrate for a liquid filter of the present disclosure should not be construed as being limited to the following specific examples.

In the following description, synthesis, treatment, production, and the like were performed at room temperature (25° C.±3° C.), unless otherwise specified.

### <Measurement Method and Evaluation Method>

In all of Examples and Comparative Examples, a polyolefin microporous membrane having a width of 270 mm was produced by winding around a winding core having an inner diameter of 3 inches. Samples cut into appropriate size from the produced polyolefin microporous membrane were subjected to physical property measurement or performance evaluation. Methods for measuring physical properties and methods for evaluating performance are as follows.

### [Calcium Content of Polyolefin]

0.1 g of polyolefin was precisely weighed into a fluororesin container and subjected to microwave decomposition with addition of ultrapure nitric acid. The calcium (Ca) content was quantified with a digit of ppb by ICP-MS (inductively coupled plasma mass spectrometry, apparatus name: Aglient 7500 cs, Agilent Technologies).

### [Particle Diameter of Polyolefin Powder]

The volume-based particle size distribution of the polyolefin powder was determined by dry measurement using a laser diffraction particle size distribution analyzer (apparatus name: Mastersizer 2000, Malvern Instruments Ltd.), and the median diameter (d50) was defined as the particle diameter.

### [Membrane Thickness of Polyolefin Microporous Membrane]

Using a contact type film thickness meter (Mitutoyo Corporation) equipped with a cylindrical contact probe having a bottom surface diameter of 0.5 cm, the thickness (μm) of the polyolefin microporous membrane was measured at 10 points at 26 mm intervals in the TD direction, and the measured values were averaged. The measurement pressure of the contact probe was set to 0.1 N.

### [Porosity of Polyolefin Microporous Membrane]

The porosity (c) of the polyolefin microporous membrane was determined from the following formula.

$$ε ( \% ) = \{ 1 - Ws / ( ds \cdot t ) \} \times 100$$

Ws: The basis weight (g/m²) of the polyolefin microporous membrane: The polyolefin microporous membrane was cut into squares of 10 cm in MD×10 cm in TD from a total of three locations, one at the center and one near each end of TD, the mass was measured, and the mass was divided by the area. Further, an average of the values at the center and near each end of TD was calculated and defined as Ws.
ds: The true density (g/cm³) of the polyolefin microporous membrane was 0.96.
t: Membrane thickness (μm) of the polyolefin microporous membrane: Determined as described above.

### [Pore Diameter of Polyolefin Microporous Membrane]

Along the TD of the polyolefin microporous membrane, the flow pore diameter was measured at a total of five points including a center, two points located 50 mm from the center toward each end, and two points located 100 mm from the center toward each end, and the measured values were averaged. The flow pore diameter was measured as follows.

The flow pore diameter was measured by the half dry method defined in ASTM E1294-89 using a perm porometer (PMI, Capillary Flow Porometer, model: CFP-1500A) with a fluorine-based inert liquid (trade name: Fluorinert, surface tension: 16.0 dyn/cm) as an immersion liquid. The measurement temperature was 25° C., the measurement pressure was changed in the range of 0 psi to 500 psi, and the measurement was performed under the following conditions.
Bubble point parameters: BUBLFLOW=50, F/PT=100, MINBPPRES=0, ZEROTIME=1, PULSEDELAY=2
Wet parameters: V2INCR=15, PREGINC=0.9, MINEQTIME=30, PRESSLEW=30, FLOWSLEW=30, EQITER=50, AVEITER=10, MAXPDIF=1, MAXFDIF=30
Dry parameters: V2INCR=40, PREGINC=2.4, MINEQTIME=30, PRESSLEW=30, FLOWSLEW=30, EQITER=40, AVEITER=10, MAXPDIF=1, MAXFDIF=30

### [Water Flow Rate of Polyolefin Microporous Membrane]

The polyolefin microporous membrane was cut into squares of 40 mm×40 mm from a total of three locations, one at the center and one near each end of the TD, immersed in ethanol, and dried at room temperature.

A polyolefin microporous membrane was placed in a stainless steel liquid permeable cell (liquid permeable area: 10.75 cm²) having a diameter of 37 mm. After the polyolefin microporous membrane on the liquid permeable cell was wetted with a small amount (0.5 ml) of ethanol, 100 ml of pure water was filtered through the membrane, under environmental conditions at 24° C. room temperature and a differential pressure of 90 kPa, and the time Tl (min) required for the entire volume of pure water to pass through was measured.

From the liquid amount V (100 ml) of the pure water, the time Tl (min), and the liquid permeable area S (10.75 cm²), the water flow rate Vs (the water flow rate per unit time (min)·unit area (ft²) under 1 psi differential pressure, unit: L/min/ft²/psi) was calculated by the following formula, and the average of the values at the center and near each end of TD was calculated.

$$Vs = ( V / 1000 ) / T 1 / ( S / 929.03 ) / ( 90 / 6.895 )$$

### [Weight Average Molecular Weight (Mw) of Polyolefin]

The polyolefin microporous membrane was heated and dissolved in o-dichlorobenzene, and the molecular weight was measured by gel permeation chromatography (system: Alliance GPC 2000 type manufactured by Waters Corporation, column: GMH6-HT and GMH6-HTL) under the conditions of a column temperature of 135° C. and a flow rate of 1.0 mL/min. Molecular weight monodisperse polystyrene (Tosoh Corporation) was used to calibrate the molecular weight.

### [Crystallinity of Polyolefin]

The polyolefin microporous membrane was cut out from the center of TD direction into a size of 10 mm in MD×3 mm in TD, and laminated to a thickness of 1 mm with the directions of MD and TD aligned, and this was used as a sample.

The sample was fixed to the sample holder of the 2D-WAXD device (model number: NANO-Viewer, Rigaku Corporation). At this time, the MD of the sample was fixed in the meridian direction such that X-rays were perpendicularly incident on the surface of the polyolefin microporous membrane. The transmission measurement was performed under the following conditions.
X-ray generator: ultrax18
Tube voltage/tube current: 45 kV/60 mA
Target: Cukα (λ=0.1542 nm)
Camera length: 95 mm
Measurement time: 10 minutes
Measurement temperature: room temperature
Detector: imaging plate

The two-dimensional data obtained by the imaging plate was converted into a 2θ profile, and peak fitting was performed in the range of 2θ=8° to 33° using a Gaussian function/Lorenz function=50/50. The integrated intensity of each peak was obtained, and the crystalline integrated intensity Ic, which is the sum of the peak intensities of the crystalline components, and the amorphous integrated intensity Ia, which is the sum of the peak intensities of the amorphous components, were obtained. The crystallinity Xc was calculated by the following formula.

$$Xc ( \% ) = Ic / ( Ic + Ia ) \times 100$$

### [Collecting Performance]

A gold colloid (Funakoshi Co., Ltd., particle diameter: 4.5 to 6.0 nm) having a particle diameter of 5 nm was dispersed in water to prepare a dispersion having a gold colloid concentration of 40 ppb.

The polyolefin microporous membrane was cut into squares of 50 mm×50 mm from a total of three locations, one at the center and one near each end of TD, immersed in ethanol, and dried at room temperature.

A polyolefin microporous membrane was placed in a stainless steel liquid permeable cell (liquid permeable area: 10.75 cm²) having a diameter of 37 mm. After the polyolefin microporous membrane on the liquid permeable cell was wetted with a small amount (0.5 ml) of ethanol, 200 ml of the gold colloid dispersion liquid was filtered through the membrane under a differential pressure of 0.1 MPa.

The metal concentration of the colloidal gold dispersion after passing through the polyolefin microporous membrane was measured and quantified using the ICP-OES method (high-frequency inductively coupled plasma emission spectrometry, apparatus name: Agilent-ICP-OES-5100, Agilent Technologies, Inc.). A calibration curve for quantification was prepared by a standard dispersion of gold colloid (5 samples or more in a concentration range of 0 ppb to 100 ppb were prepared).

The collection ratio (%)={(M1−M2)/M1×100} was calculated from the initial metal concentration M1 (that is, 40 ppb) of the colloidal gold dispersion and the metal concentration M2 of the colloidal gold dispersion after passing through the polyolefin microporous membrane. The average of the values at the center and near each end of TD was calculated, and the average value was classified as follows.
A: Average value of the collection ratio is 90% or more.
B: Average value of the collection ratio is less than 90% and 80% or more.
C: Average value of the collection ratio is less than 80%.

### [Metal Elution]

Adherents (such as fine powder generated during the production of the polyolefin microporous membrane and dust in the air, that is, those not integrated with the polyolefin microporous membrane) were removed from both surfaces of the polyolefin microporous membrane. The polyolefin microporous membrane was cut into square pieces (10 cm×10 cm, 40 sheets, total area: 4000 cm²), and this was used as a sample.

A sample was placed in a fluororesin container, 200 g of a hydrochloric acid extraction solution (a mixture of water and isopropyl alcohol in a mass ratio of 40:60, containing hydrochloric acid at a concentration of 10% by mass) was added to immerse the sample in the hydrochloric acid extraction solution. After 24 hours, the sample was taken out and dried.

The dried sample was placed in another fluororesin container, and 200 g of propylene glycol monomethyl ether (PGME) was added to immerse the sample in the PGME.

At 24 hours and 168 hours after immersion, the concentrations of Ca and Zn in the PGME were quantitatively determined down to the 0.1 ppb level by the ICP-OES method (high-frequency inductively coupled plasma emission spectroscopy, apparatus name: Agilent-ICP-OES-5100, Agilent Technologies, Inc.).

The total elution amounts (μg/m²) of Ca and Zn eluted from the polyolefin microporous membrane were calculated based on the determined concentrations of Ca and Zn, the mass of PGME, and the sample area. The elution increase rate (%)={(total elution amount at 168 hours−total elution amount at 24 hours)/total elution amount at 24 hours×100) was calculated and classified as follows.
A: Elution increase rate is less than 5%
B: Elution increase rate is 5% or more and less than 10%
C: Elution increase rate is 10% or more

### [Thermal Shrinkage Rate in TD]

The polyolefin microporous membrane was cut into squares of 10 cm in MD×10 cm in TD from a total of three locations, one at the center and one near each end of TD. The samples were placed in an oven maintained at an internal temperature of 105° C. for 30 minutes. The samples were taken out from the oven, and the TD length of the sample was measured. The thermal shrinkage rates (%) in TD={(TD length before heat treatment−TD length after heat treatment)/TD length before heat treatment×100} were calculated. Further, the averages of the values at the center and near each end of TD calculated and classified as follows.
A: The thermal shrinkage rate in TD is 10% or less.
B: The thermal shrinkage rate in TD is more than 10% and 20% or less.
C: The thermal shrinkage rate in TD is more than 20%.

### <Production of Substrate for Liquid Filter>

Hereinafter, “UHMWPE” means ultra-high molecular weight polyethylene having a weight average molecular weight of 3,000,000 to 6,000,000, and “HDPE” means high-density polyethylene having a weight average molecular weight of 200,000 to 800,000 and a density of 0.92 g/cm³ to 0.98 g/cm³.

### Example 1

### -Step (1)-

UHMWPE having Mw of 4,600,000 and Ca content of 140 ppb: 22 parts by mass

### (Particle Diameter of Powder of UHMWPE: 60 μm)

HDPE having Mw of 500,000 and Ca content of 230 ppb: 5 parts by mass

### (Particle Diameter of Powder of HDPE: 250 μm)

Liquid paraffin: 72 parts by mass
Decalin: 1 part by mass

The above materials were prepared. Liquid paraffin and decalin were mixed to prepare a mixed solvent. The entire amount of UHMWPE was added to the mixed solvent and stirred to mix. Next, the entire amount of HDPE was added and stirred to mix. In this way, a polyethylene solution having a polyethylene concentration of 27% by mass was prepared. The Ca content in the mixture of UHMWPE and HDPE was 157 ppb.

### -Step (2)-

The polyethylene solution was fed into a twin-screw kneading extruder and the extruder was operated at a screw rotation speed of 200 rpm to apply pressure and heat to the polyethylene solution. The temperature inside the barrel of the twin-screw kneading extruder was adjusted so that the temperature of the polyethylene solution temperature in the most downstream region reached 200° C., and the temperature of the polyethylene solution in the die was adjusted to reach 190° C.

The polyethylene solution was extruded from a die into a sheet form, and the extruded product was conveyed into a water bath at a water temperature of 20° C. for cooling, thereby producing a gel-like sheet also referred to as base tape.

### -Step (3)-

The base tape was withdrawn from the water bath, conveyed through the space at a temperature of 60° C. for 10 minutes, and then was conveyed through the space at a temperature of 95° C. for another 10 minutes, thereby removing decalin from the base tape.

Next, the base tape was conveyed over a roller with a surface temperature of 90° C. while applying a pressure of 0.05 MPa, thereby removing a portion of the liquid paraffin from the base tape.

### -Step (4)-

The base tape was stretched in the MD direction at a temperature of 100° C. with a stretching ratio of 7 (longitudinal stretching), then stretched in the TD direction at a temperature of 115° C. with a stretching ratio of 25 (transverse stretching), and immediately thereafter subjected to heat-setting at a temperature of 115° C., thereby obtaining a polyolefin microporous membrane.

### -Step (5)-

The polyolefin microporous membrane was continuously immersed for 30 seconds each in a methylene chloride bath divided into three tanks (referred to as the first tank, second tank, and third tank in order from the upstream), and liquid paraffin was extracted from the polyolefin microporous membrane. Methylene chloride was poured into the third tank, and methylene chloride was allowed to flow from the third tank toward the first tank, thereby forming a gradient in methylene chloride purity (first tank<second tank<third tank).

The polyolefin microporous membrane was withdrawn from the methylene chloride bath, conveyed through the space at a temperature of 40° C., and methylene chloride was removed from the polyolefin microporous membrane.

### -Step (6)-

The polyolefin microporous membrane was subjected to annealing by being conveyed through a thermostatic chamber at a temperature of 110° C. for 1 minute while maintaining a constant TD length.

Next, the polyolefin microporous membrane was conveyed through a space at a temperature of 60° C. for 20 seconds, then conveyed into a room-temperature space and cooled.

The obtained polyethylene microporous membrane had a structure in which fibril-like polyolefin formed a three-dimensional network, containing a large number of micropores inside, and had a structure in which the micropores were connected to each other, allowing gas or liquid to pass from one surface to the other surface. The properties of the polyethylene microporous membrane (the substrate for a liquid filter of the present disclosure) are shown in Table 1.

### Example 2

A polyethylene microporous membrane was produced in the same manner as in Example 1 except that step (4) was changed as follows.

### -Step (4)-

The base tape was stretched in the MD direction at a temperature of 100° C. with a stretching ratio of 6 (longitudinal stretching), then stretched in the TD direction at a temperature of 110° C. with a stretching ratio of 16 (transverse stretching), and immediately thereafter subjected to heat-setting at a temperature of 120° C., thereby obtaining a polyolefin microporous membrane.

The obtained polyethylene microporous membrane had a structure in which fibril-like polyolefin formed a three-dimensional network, containing a large number of micropores inside, and had a structure in which the micropores were connected to each other, allowing gas or liquid to pass from one surface to the other surface. The properties of the polyethylene microporous membrane (the substrate for a liquid filter of the present disclosure) are shown in Table 1.

### Example 3

A polyethylene microporous membrane was produced in the same manner as in Example 1 except that the steps (1), (2), and (4) were changed as follows.

### -Step (1)-

UHMWPE having Mw of 4,200,000 and Ca content of 31 ppm: 15 parts by mass

### (Particle Diameter of Powder of UHMWPE: 30 μm)

HDPE having Mw of 400,000 and Ca content of 34 ppm: 15 parts by mass

### (Particle Diameter of Powder of HDPE: 20 μm)

Liquid paraffin: 65 parts by mass
Decalin: 5 parts by mass

The above materials were prepared. Liquid paraffin and decalin were mixed to prepare a mixed solvent. The entire amount of UHMWPE was added to the mixed solvent and stirred to mix. Next, the entire amount of HDPE was added and stirred to mix. In this way, a polyethylene solution having a polyethylene concentration of 30% by mass was prepared. The Ca content in the mixture of UHMWPE and HDPE was 32.5 ppm.

### -Step (2)-

The polyethylene solution was fed into a twin-screw kneading extruder and the extruder was operated at a screw rotation speed of 100 rpm to apply pressure and heat to the polyethylene solution. The temperature inside the barrel of the twin-screw kneading extruder was adjusted so that the temperature of the polyethylene solution in the most downstream region reached 175° C., and the temperature of the polyethylene solution in the die was adjusted to reach 170° C.

The polyethylene solution was extruded from a die into a sheet form, and the extruded product was conveyed into a water bath at a water temperature of 20° C. for cooling, thereby producing a gel-like sheet also referred to as base tape.

### -Step (4)-

The base tape was stretched in the MD direction at a temperature of 100° C. with a stretching ratio of 5 (longitudinal stretching), then stretched in the TD direction at a temperature of 115° C. with a stretching ratio of 12 (transverse stretching), and immediately thereafter subjected to heat-setting at a temperature of 124° C., thereby obtaining a polyolefin microporous membrane.

The obtained polyethylene microporous membrane had a structure in which fibril-like polyolefin formed a three-dimensional network, containing a large number of micropores inside, and had a structure in which the micropores were connected to each other, allowing gas or liquid to pass from one surface to the other surface. The properties of the polyethylene microporous membrane (the substrate for a liquid filter of the present disclosure) are shown in Table 1.

### Example 4

A polyethylene microporous membrane was produced in the same manner as in Example 1 except that the steps (1), (2), and (4) were changed as follows.

### -Step (1)-

UHMWPE having Mw of 4, 200,000 and Ca content of 31 ppm: 18 parts by mass

### (Particle Diameter of Powder of UHMWPE: 30 μm)

HDPE having Mw of 400,000 and Ca content of 34 ppm: 5 parts by mass

### (Particle Diameter of Powder of HDPE: 20 μm)

Liquid paraffin: 75 parts by mass
Decalin: 2 parts by mass

The above materials were prepared. Liquid paraffin and decalin were mixed to prepare a mixed solvent. The entire amount of UHMWPE was added to the mixed solvent and stirred to mix. Next, the entire amount of HDPE was added and stirred to mix. In this way, a polyethylene solution having a polyethylene concentration of 23% by mass was prepared. The Ca content in the mixture of UHMWPE and HDPE was 31.7 ppm.

### -Step (2)-

The polyethylene solution was fed into a twin-screw kneading extruder and the extruder was operated at a screw rotation speed of 220 rpm to apply pressure and heat to the polyethylene solution. The temperature inside the barrel of the twin-screw kneading extruder was adjusted so that the temperature of the polyethylene solution in the most downstream region reached 200° C., and the temperature of the polyethylene solution in the die was adjusted to reach 190° C.

The polyethylene solution was extruded from a die into a sheet form, and the extruded product was conveyed into a water bath at a water temperature of 20° C. for cooling, thereby preparing a gel-like sheet also referred to as base tape.

### -Step (4)-

The base tape was stretched in the MD direction at a temperature of 100° C. with a stretching ratio of 9 (longitudinal stretching), then stretched in the TD direction at a temperature of 105° C. with a stretching ratio of 18 (transverse stretching), and immediately thereafter subjected to heat-setting at a temperature of 110° C., thereby obtaining a polyolefin microporous membrane.

The obtained polyethylene microporous membrane had a structure in which fibril-like polyolefin formed a three-dimensional network, containing a large number of micropores inside, and had a structure in which the micropores were connected to each other, allowing gas or liquid to pass from one surface to the other surface. The properties of the polyethylene microporous membrane (the substrate for a liquid filter of the present disclosure) are shown in Table 1.

### Example 5

A polyethylene microporous membrane was produced in the same manner as in Example 1 except that the steps (1) and (6) were changed as follows.

### -Step (1)-

UHMWPE having Mw of 4,600,000 and Ca content of 140 ppb: 4 parts by mass

### (Particle Diameter of Powder of UHMWPE: 60 μm)

HDPE having Mw of 500,000 and Ca content of 230 ppb: 16 parts by mass

### (Particle Diameter of Powder of HDPE: 250 μm)

Liquid paraffin: 80 parts by mass

The above materials were prepared. The entire amount of UHMWPE was added to the liquid paraffin, and the mixture was stirred to mix. Next, the entire amount of HDPE was added and stirred to mix. In this way, a polyethylene solution having a polyethylene concentration of 20% by mass was prepared. The Ca content in the mixture of UHMWPE and HDPE was 212 ppb.

### -Step (6)-

The polyolefin microporous membrane was subjected to annealing by being conveyed through a thermostatic chamber at a temperature of 115° C. for 1 minute while maintaining a constant TD length.

Next, the polyolefin microporous membrane was conveyed through a space at a temperature of 60° C. for 20 seconds, then conveyed into a room-temperature space, and cooled.

The obtained polyethylene microporous membrane had a structure in which a fibril-like polyolefin formed a three-dimensional network, containing a large number of micropores inside, and had a structure in which the micropores were connected to each other, allowing gas or liquid to pass from one surface to the other surface. The properties of the polyethylene microporous membrane (the substrate for a liquid filter of the present disclosure) are shown in Table 1.

### Example 6

A polyethylene microporous membrane was produced in the same manner as in Example 1 except that the steps (1), (2), and (4) were changed as follows.

### -Step (1)-

UHMWPE having Mw of 4, 600,000 and Ca content of 140 ppb: 15 parts by mass

### (Particle Diameter of Powder of UHMWPE 60 μm)

HDPE having Mw of 500,000 and Ca content of 230 ppb: 5 parts by mass

### (Particle Diameter of Powder of HDPE: 250 μm)

Liquid paraffin: 80 parts by mass

The above materials were prepared. The entire amount of UHMWPE was added to the liquid paraffin, and the mixture was stirred to mix. Next, the entire amount of HDPE was added and stirred to mix. In this way, a polyethylene solution having a polyethylene concentration of 20% by mass was prepared. The Ca content in the mixture of UHMWPE and HDPE was 162.5 ppb.

### -Step (2)-

The polyethylene solution was fed into a twin-screw kneading extruder and the extruder was operated at a screw rotation speed of 400 rpm to apply pressure and heat to the polyethylene solution. The temperature inside the barrel of the twin-screw kneading extruder was adjusted so that the temperature of the polyethylene solution in the most downstream region reached 200° C., and the temperature of the polyethylene solution in the die was adjusted to reach 210° C.

The polyethylene solution was extruded from a die into a sheet form, and the extruded product was conveyed into a water bath at a water temperature of 20° C. for cooling, thereby producing a gel-like sheet also referred to as base tape.

### -Step (4)-

The base tape was stretched in the MD direction at a temperature of 110° C. with a stretching ratio of 6 (longitudinal stretching), then stretched in the TD direction at a temperature of 115° C. with a stretching ratio of 13 (transverse stretching), and immediately thereafter subjected to heat-setting at a temperature of 130° C., thereby obtaining a polyolefin microporous membrane.

The obtained polyethylene microporous membrane had a structure in which a fibril-like polyolefin formed a three-dimensional network, containing a large number of micropores inside, and had a structure in which the micropores were connected to each other, allowing gas or liquid to pass from one surface to the other surface. The properties of the polyethylene microporous membrane (the substrate for a liquid filter of the present disclosure) are shown in Table 1.

### Comparative Example 1

A polyethylene microporous membrane was produced in the same manner as in Example 1 except that the steps (2) and (4) were changed as follows.

### -Step (2)-

The polyethylene solution was fed into a twin-screw kneading extruder and the extruder was operated at a screw rotation speed of 200 rpm to apply pressure and heat to the polyethylene solution. The temperature inside the barrel of the twin-screw kneading extruder was adjusted so that the temperature of the polyethylene solution in the most downstream region reached 160° C., and the temperature of the polyethylene solution in the die was adjusted to reach 165° C.

The polyethylene solution was extruded from a die into a sheet form, and the extruded product was conveyed into a water bath at a water temperature of 20° C. for cooling, thereby producing a gel-like sheet also referred to as base tape.

### -Step (4)-

The base tape was stretched in the MD direction at a temperature of 100° C. with a stretching ratio of 9 (longitudinal stretching), then stretched in the TD direction at a temperature of 105° C. with a stretching ratio of 25 (transverse stretching), and immediately thereafter subjected to heat-setting at a temperature of 105° C., thereby obtaining a polyolefin microporous membrane.

The obtained polyethylene microporous membrane had a structure in which fibril-like polyolefin formed a three-dimensional network, containing a large number of micropores inside, and had a structure in which the micropores were connected to each other, allowing gas or liquid to pass from one surface to the other surface. The properties of the polyethylene microporous membrane are shown in Table 1.

### Comparative Example 2

A polyethylene microporous membrane was produced in the same manner as in Example 1 except that the step (4) was changed as follows.

### -Step (4)-

The base tape was stretched in the MD direction at a temperature of 100° C. with a stretching ratio of (longitudinal stretching), then stretched in the TD direction at a temperature of 115° C. with a stretching ratio of 25 (transverse stretching), and immediately thereafter subjected to heat-setting at a temperature of 100° C., thereby obtaining a polyolefin microporous membrane.

The obtained polyethylene microporous membrane had a structure in which fibril-like polyolefin formed a three-dimensional network, containing a large number of micropores inside, and had a structure in which the micropores were connected to each other, allowing gas or liquid to pass from one surface to the other surface. The properties of the polyethylene microporous membrane are shown in Table 1.

### Comparative Example 3

A polyethylene microporous membrane was produced in the same manner as in Example 1 except that the steps (1) and (4) were changed as follows.

### -Step (1)-

UHMWPE having Mw of 4,600,000 and Ca content of 140 ppb: 27 parts by mass

### (Particle Diameter of Powder of UHMWPE: 60 μm)

HDPE having Mw of 500,000 and Ca content of 230 ppb: 2 parts by mass

### (Particle Diameter of Powder of HDPE: 250 μm)

Liquid paraffin: 70 parts by mass
Decalin: 1 part by mass

The above materials were prepared. Liquid paraffin and decalin were mixed to prepare a mixed solvent. The entire amount of UHMWPE was added to the mixed solvent and stirred to mix. Next, the entire amount of HDPE was added and stirred to mix. In this way, a polyethylene solution having a polyethylene concentration of 29% by mass was prepared. The Ca content in the mixture of UHMWPE and HDPE was 146 ppb.

### -Step (4)-

The base tape was stretched in the MD direction at a temperature of 105° C. with a stretching ratio of 9 (longitudinal stretching), then stretched in the TD direction at a temperature of 105° C. with a stretching ratio of 25 (transverse stretching), and immediately thereafter subjected to heat-setting at a temperature of 108° C., thereby obtaining a polyolefin microporous membrane.

The obtained polyethylene microporous membrane had a structure in which fibril-like polyolefin formed a three-dimensional network, containing a large number of micropores inside, and had a structure in which the micropores were connected to each other, allowing gas or liquid to pass from one surface to the other surface. The properties of the polyethylene microporous membrane are shown in Table 1.

### Comparative Example 4

A polyethylene microporous membrane was produced in the same manner as in Example 1 except that the steps (1), (2), (4), and (6) were changed as follows.

### -Step (1)-

UHMWPE having Mw of 4,200,000 and Ca content of 31 ppm: 3 parts by mass

### (Particle Diameter of Powder of UHMWPE: 30 μm)

HDPE having Mw of 400,000 and Ca content of 34 ppm: 14 parts by mass

### (Particle Diameter of Powder of HDPE: 20 μm)

Liquid paraffin: 51 parts by mass
Decalin: 32 parts by mass

The above materials were prepared. Liquid paraffin and decalin were mixed to prepare a mixed solvent. The entire amount of UHMWPE was added to the mixed solvent and stirred to mix. Next, the entire amount of HDPE was added and stirred to mix. In this way, a polyethylene solution having a polyethylene concentration of 17% by mass was prepared. The Ca content in the mixture of UHMWPE and HDPE was 33.5 ppm.

### -Step (2)-

The polyethylene solution was fed into a twin-screw kneading extruder and the extruder was operated at a screw rotation speed of 450 rpm to apply pressure and heat to the polyethylene solution. The temperature inside the barrel of the twin-screw kneading extruder was adjusted so that the temperature of the polyethylene solution in the most downstream region reached 160° C., and the temperature of the polyethylene solution in the die was adjusted to reach 160° C.

The polyethylene solution was extruded from a die into a sheet form, and the extruded product was conveyed into a water bath at a water temperature of 20° C. for cooling, thereby producing a gel-like sheet also referred to as base tape.

### -Step (4)-

The base tape was stretched in the MD direction at a temperature of 100° C. with a stretching ratio of 4 (longitudinal stretching), then stretched in the TD direction at a temperature of 110° C. with a stretching ratio of 9 (transverse stretching), and then immediately thereafter subjected to heat-setting at a temperature of 135° C., thereby obtaining a polyolefin microporous membrane.

### -Step (6)-

The polyolefin microporous membrane was subjected to annealing by being conveyed through a thermostatic chamber at a temperature of 100° C. for 1 minute while maintaining a constant TD length.

Next, the polyolefin microporous membrane was conveyed through a space at a temperature of 60° C. for 20 seconds, then conveyed into a room-temperature space, and cooled.

The obtained polyethylene microporous membrane had a structure in which fibril-like polyolefin formed a three-dimensional network, containing a large number of micropores inside, and had a structure in which the micropores were connected to each other, allowing gas or liquid to pass from one surface to the other surface. The properties of the polyethylene microporous membrane are shown in Table 1.

TABLE 1

| | | | | | | | Substrate for a liquid filter | | |
|---|---|---|---|---|---|---|---|---|---|
| | Polyolefin microporous membrane | | | | | | | | TD |
| | | | | Water Flow | | Crystallinity | | | Thermal |
| | | | Pore | Rate | Mw of | of | Collecting | Metal | Shrinkage |
| | Thickness | Porosity | Diameter | L/min/ | Polyolefin | Polyolefin | Performance | Elution | Rate |
| | μm | % | nm | ft²/psi | ×10⁴ | % | — | — | — |
| Example 1 | 6 | 43 | 14 | 0.008 | 280 | 47 | A | A | B |
| Example 2 | 6 | 53 | 18 | 0.025 | 293 | 53 | A | A | A |
| Example 3 | 10 | 50 | 18 | 0.014 | 173 | 54 | A | A | A |
| Example 4 | 9 | 49 | 16 | 0.010 | 260 | 49 | A | B | B |
| Example 5 | 6 | 65 | 35 | 0.152 | 89 | 63 | B | A | A |
| Example 6 | 8 | 62 | 31 | 0.102 | 261 | 55 | B | A | A |
| Comparative | 6 | 43 | 16 | 0.012 | 276 | 43 | A | C | C |
| Example 1 | | | | | | | | | |
| Comparative | 5 | 40 | 14 | 0.005 | 273 | 40 | A | C | C |
| Example 2 | | | | | | | | | |
| Comparative | 5 | 40 | 16 | 0.008 | 269 | 42 | A | C | C |
| Example 3 | | | | | | | | | |
| Comparative | 12 | 54 | 57 | 0.122 | 91 | 67 | C | A | A |
| Example 4 | | | | | | | | | |

Comparative Example 4, in which the pore diameter of the polyolefin microporous membrane is 57 nm, is inferior in the evaluation item “collecting performance”.

In contrast, Examples 1 to 6, in which the pore diameter of the polyolefin microporous membrane is 35 nm or less (the substrate for a liquid filter of the present disclosure), are excellent in the evaluation item “collecting performance”. That is, the substrate for a liquid filter of the present disclosure is excellent in the performance of filtering fine particles (for example, particles having a particle diameter of 5 nm) present in the liquid to be treated.

Comparative Examples 1 to 3, in which the crystallinity of the polyolefin is less than 45%, are inferior in the evaluation item “metal elution”.

In contrast, Examples 1 to 6, in which the crystallinity of the polyolefin is 45% or more (the substrate for a liquid filter of the present disclosure), are excellent in the evaluation item “metal elution”. That is, the substrate for a liquid filter of the present disclosure, although having a relatively small pore diameter, allows residual metals to be easily removed by washing.

All documents, patent applications, and technical standards described in the present specification are incorporated by reference in the present specification to the same extent as when individual documents, patent applications, and technical standards are specifically and individually described.

The disclosure of Japanese Patent Application No. 2023-052236 filed on Mar. 28, 2023 is all incorporated herein by reference.

1. A substrate for a liquid filter, comprising a polyolefin microporous membrane having a pore diameter of 1 nm to 35 nm and a crystallinity of polyolefin of 45% or more.

2. The substrate for a liquid filter according to claim 1, wherein the polyolefin microporous membrane has a thickness of 3 μm to 20 μm.

3. The substrate for a liquid filter according to claim 1, wherein the polyolefin microporous membrane has a porosity of 35% to 70%.

4. The substrate for a liquid filter according to claim 1, wherein the polyolefin microporous membrane has a water flow rate of 0.003 L/min/ft²/psi to 0.180 L/min/ft²/psi.

5. The substrate for a liquid filter according to claim 1, wherein a weight average molecular weight of all polyolefins constituting the polyolefin microporous membrane is 800,000 or more.

6. The substrate for a liquid filter according to claim 1, wherein the polyolefin microporous membrane is a polyethylene microporous membrane.

7. A liquid filter comprising the substrate for a liquid filter according to claim 1.
